(19) United States
(12) Patent Application Publication
(10) Pub. No.: US 2006/0132818 A1
(43) Pub. Date: Jun. 22, 2006

(54) Computer readable medium recording a driver program and image forming device

(75) Inventor: Tetsuya Suzuki, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/283,670

(22) Filed: Nov. 22, 2005

(30) Foreign Application Priority Data
Nov. 25, 2004 (JP) 2004-339869

(51) Int. Cl. G06F 3/12

(52) U.S. Cl. 358/1.13

(57) ABSTRACT

A computer readable medium recording a driver program for a printer or other image forming device, capable of performing line drawing more satisfactorily than in the prior art, is provided. When the image data for raster processing is image data representing a line, the driver program, which causes a host device to perform raster processing of image data received in vector data form and processing to generate data for an image forming device, causes the host to execute processing to decide whether or not to correct the width of the line, and when the decision is to correct the width of the line, to correct the line width and then perform raster processing for the image data after the correction, but when the decision is not to correct the line width, to perform raster processing for the received image data.

### CROSS-REFERENCE TO RELATED APPLICATIONS

This application is based upon and claims the benefit of priority from the prior Japanese Patent Application No. 2004-339869, filed on Nov. 25, 2004, the entire contents of which are incorporated herein by reference.

### BACKGROUND OF THE INVENTION

1. Field of the Invention

This invention relates to a computer readable medium recording a drive program which causes a host device to execute processing of an image forming request for a printer or other image forming device, and the like, and more particularly relates to a computer readable medium recording a drive program capable of satisfactorily drawing lines in the image forming device, and the like.

2. Description of the Related Art

In normal print processing by a printer or other image forming device, a print request is issued by a personal computer or other host device from an application, and based on this request, a driver at the host device generates print data and transmits the data to the image forming device, and the image forming device, having received the print data, performs the requested printing based on the print data.

During the period until this printing ends, image data sent from the application for which printing is requested is subjected to various processing. Specifically, expansion processing is performed to express data representing individual image objects as drawing data expressing the density value of the color of each pixel; color conversion processing is performed to convert the drawing data color representation into a color representation for the image forming device; and other processing is performed to render the color-converted data into dot images, and the like.

Further, while the above expansion processing is being performed and until drawing data is generated, processing called “rasterizing” is being performed. In general, the image data sent from an application represents each object, if the object is a graphic image, in terms of the type of the graphic, the coordinate values of vertices, lengths and other parameters, in a so-called vector data format. Processing to convert such data into so-called raster data represented as a collection of pixels (a bitmap image) is generally called “rasterizing” (see for example Japanese Patent Laid-open No. 10-100483 (paragraphs 0002, 0023)).

For example, in raster processing of a graphic image of a line, vector data represented by the coordinate values of the line endpoints and the line width is converted into raster data represented by a cluster of pixels at the location at which the line exists.

In devices in which so-called host-based processing is performed, in which the various types of processing described above up to color conversion processing are performed on the side of the host device, this raster processing is performed on the side of the host device.

In the above-described raster processing, when the graphic image is a line, in the prior art a fixed method was used for processing regardless of the type of line to be rasterized; but when the line to be processed is nearly a horizontal line or a vertical line, that is, when the line is inclined slightly from the vertical or from the horizontal, there have been cases in which the line width after rasterizing is non-uniform. Hence in such cases the appearance after image forming is poor, and an inappropriate result is obtained.

### SUMMARY OF THE INVENTION

Hence an object of the invention is to provide a computer readable medium recording a driver program for a printer or other image forming device which is capable of performing line drawing more satisfactorily than in the prior art, and the like.

In order to achieve the above object, one aspect of this invention is a computer readable medium recording a driver program which causes a host device to execute raster processing of received image data in a vector data format and processing to generate data for an image forming device, and which causes the host device to decide, when the image data for the raster processing is image data representing a line, whether to correct the width of the line based on the width and on the angle of inclination from the horizontal direction or from the vertical direction, and upon deciding that the width of the line should be corrected, to correct the width of the line and to execute the raster processing for the image data after the correction, but upon deciding that the width of the line should not be corrected, to perform the raster processing for the received image data. Hence by means of this invention, depending on the parameters of a line for image forming, raster processing is performed after line width correction, so that the lines with non-uniform line widths resulting in devices of the prior art can be improved.

Further, in the above invention, a preferred embodiment is characterized in that a decision is made to correct the line width when a condition that the inclination angle is smaller than a predetermined angle, and a condition that the line width is smaller than a predetermined width, are satisfied. By this means, appropriate line width correction is performed in cases of lines the line widths of which become non-uniform in devices of the prior art, so that the problem of non-uniformity of line widths can be alleviated.

Further, in the above invention, a preferred embodiment is characterized in that a decision is made to correct the line width when the further condition that the length of the line be longer than a predetermined length is satisfied. By this means, cases in which the line width becomes non-uniform can be decided appropriately.

Further, in the above invention, a preferred embodiment is characterized in that correction of the width of the line is correction to make thicker the width of the line. By this means, in cases in which the line width becomes non-uniform, it is possible to render the line width uniform.

In order to achieve the above object, another aspect of this invention is an image forming device which performs image processing including raster processing of received image data in a vector data format, and executes image forming based on the image data, wherein the image forming device has a rasterizing unit, when image data for the raster processing is image data representing a line, which decides whether to correct the width of the line based on the line width and the angle of inclination from the horizontal direction or from the vertical direction, upon deciding that the width of the line should be corrected, corrects the width of the line and performs the raster processing for the image data after the correction, and, but upon deciding that the width of the line should not be corrected, performs the raster processing for the received image data.

In the above invention, a preferred embodiment is characterized in that a decision is made to correct the width of the line when a condition that the inclination angle is smaller than a predetermined angle, and a condition that the line width is smaller than a predetermined width, are satisfied.

Further, in the above invention, a preferred embodiment is characterized in that a decision is made to correct the line width when the further condition that the length of the line be longer than a predetermined length is satisfied.

Further, in the above invention, a preferred embodiment is characterized in that correction of the width of the line is correction to make thicker the width of the line.

Further objects and characteristics of the invention will become clear from the explanation below of an aspect of the invention.

### BRIEF DESCRIPTION OF THE DRAWINGS

FIG. 1 shows the configuration of an aspect of the invention employing a driver program;

FIG. 2 is a flowchart showing an example of the details of raster processing of lines;

FIG. 3 is a drawing used to explain data representing lines;

FIG. 4 is a drawing used to explain the inclination angle α and similar;

FIG. 5 is a drawing used to explain correction of the line width d; and,

FIGS. 6A and 6B are drawings illustrating the results of rasterizing.

### DESCRIPTION OF THE PREFERRED EMBODIMENTS

Below, aspects of the invention are explained referring to the drawings. However, the aspects do not in any way limit the technical scope of the invention. In the drawings, the same reference numbers or reference symbols are assigned to the same or similar components.

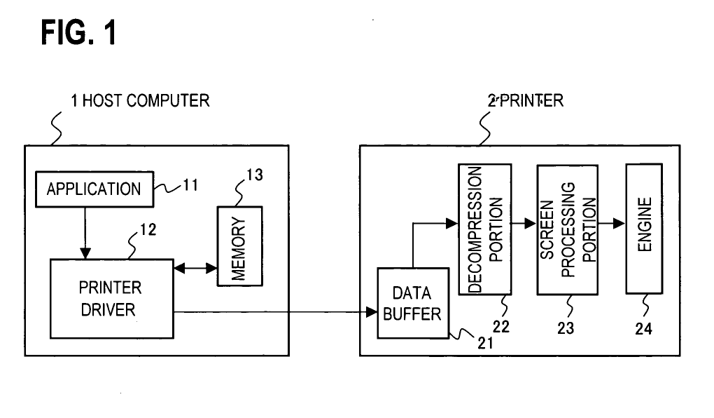

FIG. 1 shows the configuration of an aspect of a printing system employing a driver program of this invention. The printer driver 12 shown in FIG. 1 is a driver program employing this invention, in a printing system comprising a host computer 1 and printer 2; in raster processing of image data, when an image is a line, and if the line to be processed satisfies prescribed conditions, then rasterizing is performed after correction of the line width is performed, so as to alleviate non-uniformity of the line width and obtain satisfactory line drawing.

The host computer 1 is a host device in this aspect, and transmits image data to the printer 2 after color conversion and compression processing to request printing. As shown in FIG. 1, the host computer 1 comprises an application 11, printer driver 12, and memory 13. The host computer 1 can be configured as a so-called personal computer or similar. The application 11 is for example text creation software or other source of printing requests, which passes data for printing, in a prescribed format, to the printer driver 12.

The printer driver 12 is a portion which receives printing requests from the application 11, generates image data, and transmits the image data to the printer 2. Details of the processing in the printer driver 12 to generate the image data to be transmitted to the printer 2 are described below; a portion of this processing is the above-described raster processing. The printer driver 12 can be configured as a program which issues processing instructions and a control device which executes processing according to this program or similar. The above-described program is installed on the host computer 1 ‘from ’ CD and the like which stores the program, or downloaded to the host computer 1 via the Internet from the prescribed site.

The memory 13 is RAM comprised by the host computer 1, and is used for various purposes; the memory temporarily stores data in different stages until the image data for transmission to the printer 2 is generated.

The printer 2, for example a four-cycle laser printer, receives the image data from the host computer 1 and executes printing based on the image data. As shown in FIG. 1, the printer 2 comprises a data buffer 21, decompression portion 22, screen processing portion 23, and engine 24.

The data buffer 21 is a portion which stores image data transferred in succession from the printer driver 12. The decompression portion 22 is a portion which, at the start of print processing, retrieves compressed data from the data buffer 21 and performs processing to restore the data to its original state. The screen processing portion 23 is a portion which performs screen processing of data decompressed by the decompression portion 22, converting data for each pixel into dot-image data. The engine 24 is a portion which executes printing onto print media based on data resulting from screen processing.

In a printing system of the aspect having the configuration described above, the raster processing in the above-described printer driver 12 has certain characteristics, which are explained in detail below with respect to processing in the printer driver 12.

As explained above, when there is a printing request from the application 11 the printer driver 12 generates image data to transmit to the printer 2; first, the image data sent from the application 11 is successively converted into an intermediate code. Data received from the application 11 is in units of objects for drawing, in the form of vector data described above. The printer driver 12 converts this data into raster data format and marks the data at each band to generate the intermediate code.

Thereafter, expansion processing is performed to generate image data for each pixel from the intermediate code. After expansion processing, the pixel data is subjected to color conversion processing and compression processing. In color conversion processing, the RGB data of each pixel is converted into YMCK data used in printing by the printer 2. The converted data is then subjected to compression processing to compress the data and reduce the data quantity. The compressed image data is stored in memory 13, and the printer driver 12 then transmits the stored image data to the printer 2 in order, according to a predetermined transmission method.

The printer driver 12 performs processing according to the procedure described above; but there is a special characteristic to the raster processing performed in the printer driver 12 during the process of generating the intermediate code, and in particular, there is a special characteristic to the raster processing when images to be drawn are lines. The specifics of this processing are explained below.

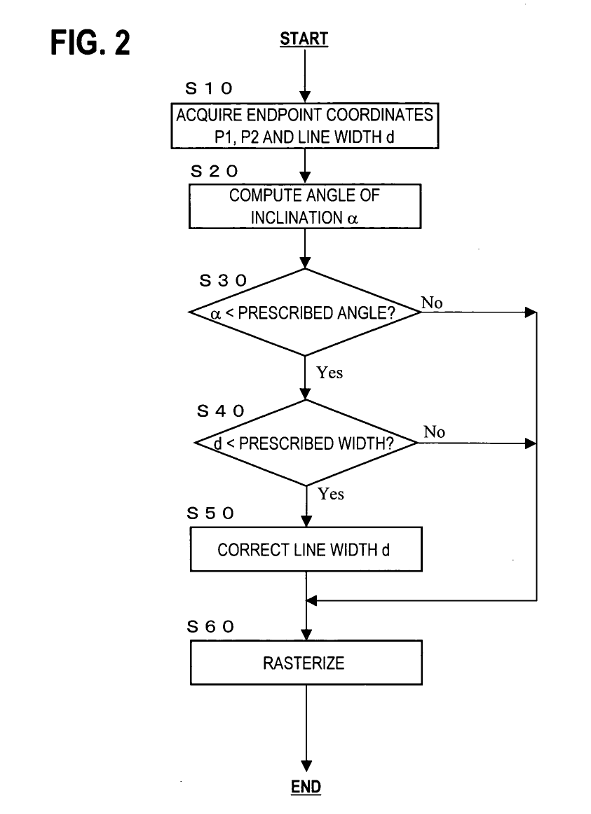

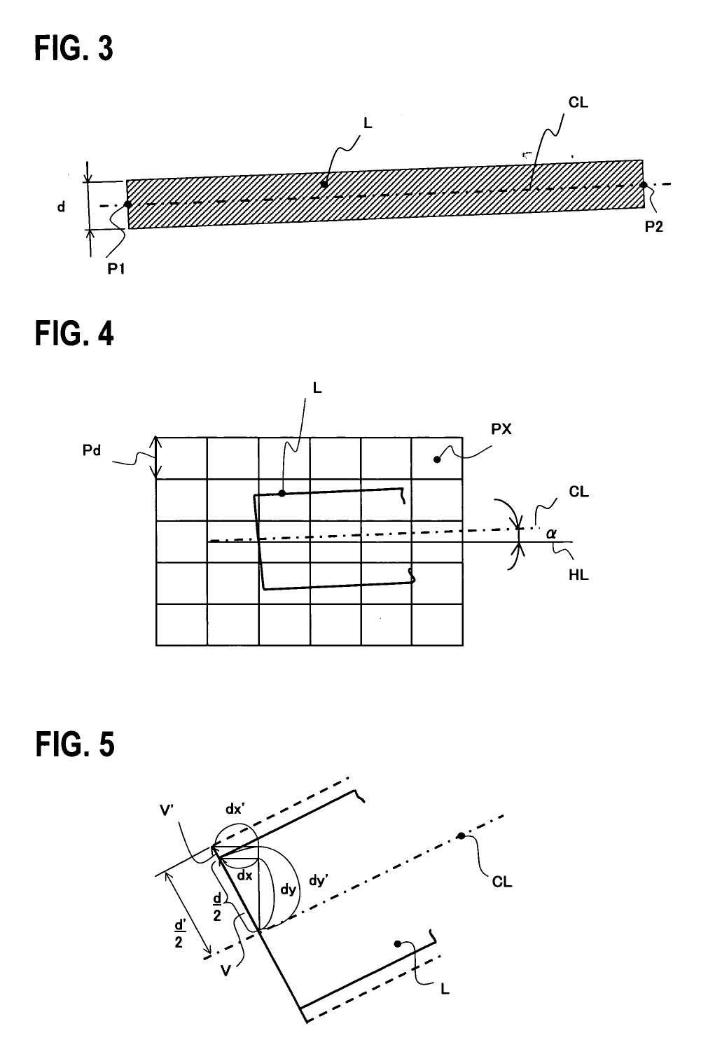

FIG. 2 is a flowchart illustrating the details of raster processing when the image is a line. First, when the image for processing is a line, the printer driver 12 receives from the application 11, as the data for the line, the coordinate values P1 and P2 of the two endpoints and the line width d (step S10). FIG. 3 is a drawing used to explain data representing the line.

If the diagonal line portion L shown in FIG. 3 is a line for drawing, then the coordinate values P1 and P2 of the two endpoints are the coordinate values of the positions shown, and the value of the line width d is the length d shown in the figure. CL in FIG. 3 is the centerline, in the center in the line width direction, of the line L.

The printer driver 12 then computes the angle of inclination α of the line L from the coordinate values P1 and P2 acquired (step S20). This angle of inclination α is the smaller angle among the angle made by the horizontal direction and the line, and the angle made by the vertical direction and the line, and can be computed mathematically from the coordinate values P1 and P2. FIG. 4 is used to explain the angle of inclination a and similar. In FIG. 4, the left-end portion of the line L illustrated in FIG. 3 is enlarged, and α in FIG. 4 is the angle of inclination α for this case. In the example shown, the line L is inclined slightly from the line HL in the horizontal direction, so that the angle made by the horizontal direction and the line L is smaller than the angle made by the vertical direction and line L, and the angle made by the horizontal direction and the line L is taken to be the angle of inclination α.

When the value of this angle of inclination α is computed, the printer driver 12 judges whether the angle α is smaller than a predetermined value (step S30). This judgment is a judgment as to whether the line in question L is a line which is inclined slightly from either the horizontal direction or from the vertical direction. Here, the predetermined value (prescribed angle) can be, for example, the angle the tangent of which is equal to 1/16. That is, when the line L is close to the horizontal direction, if there is movement within one pixel in the vertical direction upon moving 16 pixels in the horizontal direction, then the angle of inclination α of the line L is smaller than the prescribed angle. Hence in this case, the line is judged to be inclined slightly from the horizontal direction.

In this judgment, when it is judged that the angle of inclination α is not smaller than a prescribed angle (“No” in step S30), the line L is not subjected to any special processing, and raster processing of the line L is performed based on the coordinate values P1 and P2 and the line width d (S60). If on the other hand the angle of inclination α is judged to be smaller than the prescribed angle α (“Yes” in step S30), then a judgment is made as to whether the acquired line width d is smaller than a predetermined value (prescribed width) (step S40).

This judgment is a judgment as to whether the line in question L is thinner than a certain thickness, taking into account the fact that, when the line to be drawn is thin, the above-described non-uniformity of the line width occurs. In the example of FIG. 4, the line L for drawing and the pixels PX at the resolution at the time of drawing are both shown; but if the size of a pixel PX is Pd, then the prescribed width can be set to 4Pd, for example.

In this judgment, when the line width d is judged not to be smaller than a prescribed width (“No” in step S40), no special processing of the line L is performed, and rasterizing is performed based on the acquired coordinate values P1 and P2 and the line width d (S60). However, if the line width d is judged to be smaller than the prescribed width (“Yes” in S40), processing to correct the line width d is performed (step S50). In other words, when the line L for processing is inclined only slightly from the horizontal direction or from the vertical direction, and when the line is thin to at least a certain degree, there is the possibility that the line may be drawn with non-uniform width, and so the value of the line width d is corrected in order to prevent this.

Specifically, correction is performed to increase somewhat the value of the line width d. FIG. 5 is a drawing to explain correction of the line width d. In FIG. 5, the left-end portion of the line L shown in FIG. 3 is shown enlarged; the solid line represents the original line L. In this example, correction is performed to change the original line width d to d′; the line L after correction is shown by the broken line.

In FIG. 5, the vector V indicated by the arrow is a vector of length equal to half the original line width, d/2, and the x component and y component are respectively dx and dy, as indicated. On the other hand, the vector V′ shown in the figure is a vector with length equal to half the line width after correction d′/2, and with x component and y component equal to dx′ and dy′ respectively, as shown. In correction to increase the line width in this aspect, d′ is determined so as to make dy′ equal to d/2, expanding the line width. Even when the line thickness is thus increased, a line with line thickness thus corrected has only a slight inclination from the horizontal direction, as explained above, so that there is no significant expansion of the line width, and the expansion is not so large as to be noticeable after drawing. In FIG. 5, the angle of inclination between the line L and the horizontal direction is shown exaggerated.

In FIG. 5, an example is shown in which the line L is close to the horizontal direction; in cases in which the line L is close to the vertical direction also, similar line width correction is performed. That is, the x and y directions are interchanged, and d′ is determined such that dx′ is equal to d/2.

When this line width correction processing ends, the processing proceeds to rasterizing (step S60). In this rasterizing, whether or not the line width correction has been performed, similar processing is performed based on the line width and the endpoint coordinates at that time.

Specifically, the vector V (V′) shown in FIG. 5 is determined from the endpoint coordinates P1 and P2 and the line width d (d′), and the coordinates of the four vertices of the rectangular representing the area of the line L are computed. As a result the drawing area of the line L for processing is recognized, and the area is expressed as the collection of pixels positioned in this area.

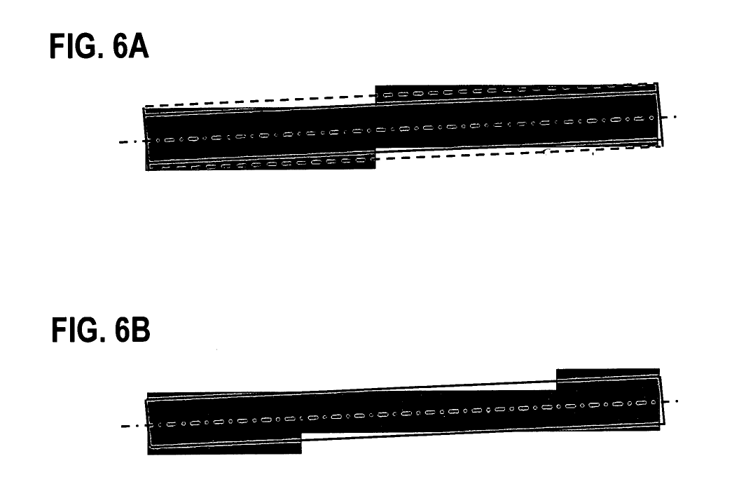

FIG. 6 illustrates the results of this rasterizing. In FIG. 6A shows the results of rasterizing for the example of FIG. 3 through FIG. 5, that is, when the line width is corrected. In FIG. 6A, the rectangle with upper and lower edges indicated by dashed lines is the area of the line L, and the filled portion is the result of rasterizing this area (the group of pixels). In the drawing, the rectangle the upper and lower edges of which are solid lines is the area of the line L before line width correction. In this example, in the group of filled pixels there exist vertical-direction columns of three pixels.

On the other hand, FIG. 6B shows the result of rasterizing of the same line L for processing as in FIG. 6A, with line width correction not performed. In other words, the result of rasterizing using the method of the prior art is shown. Here, rasterizing is performed of the rectangular area of the line L indicated by solid lines, and the filled area is the result of the rasterizing.

In the case of FIG. 6B, from the figure, as a result of rasterizing the width of the line L becomes narrower only in the center portion, and so a line which originally is of uniform width is drawn as a line of non-uniform width. However, as the result of the rasterizing of this aspect, as shown in FIG. 6A, a line of uniform width, albeit with a step, is drawn. Thus the problem of a non-uniform width when drawing a prescribed line can be alleviated.

In FIG. 6, the case of a line for processing which is close to the horizontal direction is explained; but a similar rasterizing result is obtained in cases in which the line for processing is close to the vertical direction, and a similar advantageous result is obtained.

In this way rasterizing (S60) is performed, and based on the data of the collection of pixels generated, the printer driver 12 generates the intermediate code in succession.

In the above, raster processing, which is a characteristic of this aspect, has been explained; however, a condition relating to the length of the line L may be added to the conditions described above for performing correction of the line width (steps S30 and S40 in FIG. 2). Specifically, when the length of the line obtained from the endpoint coordinates P1 and P2 acquired from the application 11 is longer than a predetermined value, line width correction is performed. This is because when the line for processing is short to a certain degree, the above-described width non-uniformity does not tend to occur. Hence the line width is expanded when the line L for processing is close to a horizontal line or vertical line, when the line width is narrow to a certain degree, and when the line length is long to a certain degree.

As a modification of the above aspect, the raster processing may be performed on the side of the printer 2. That is, the printing system of the above aspect is a so-called host-based system, but the above-described line raster processing may also be applied to a system which is not host-based. In this case, the printer 2 receives image data in vector data form and generates the intermediate codes and the drawing data from this data; the printer 2 has rasterizing unit, and when, in the process of generating intermediate codes, a line is to be processed, the above raster processing explained using FIG. 2 is executed. By this means, an advantageous result similar to that of the above aspect can be obtained. The above rasterizing unit can be configured through a program which issues instructions for processing and a control device which executes processing according to the program.

As explained above, in the above aspect and modified aspect, if when performing raster processing the object for processing is a line which satisfies prescribed conditions, then rasterizing is performed after line width correction. In this line width correction, correction is performed to expand the line width somewhat. By this means, as explained above, the problem of non-uniformity of the line width of the drawn line can be alleviated.

In the above-described examples, the representation in vector data form of the line was in terms of the endpoint coordinate values P1 and P2 and the line width d; but other representations suitable for a line may be employed.

The scope of protection of this invention is not limited to the above aspects, but extends to inventions described in the scope of claims and to inventions equivalent thereto.

1. A computer readable medium recording a driver program which causes a host device to execute raster processing of image data received in vector data form, and processing to generate data for an image forming device, wherein, when the image data for said raster processing is image data representing a line:
a decision is made as to whether or not to correct the width of said line, based on the width and the angle of inclination from a horizontal direction or from a vertical direction of said line; and,
when said decision is to correct the width of said line, the width of said line is corrected and said raster processing is performed for the image data after the correction, whereas when said decision is not to correct the width of said line, said raster processing is performed for said received image data.

2. The computer readable medium according to claim 1, wherein the decision to correct the width of said line is made when the condition that said angle of inclination is smaller than a predetermined angle, and the condition that the width of said line is smaller than a predetermined width, are satisfied.

3. The computer readable medium according to claim 2, wherein the decision to correct the width of said line is made when a further condition that the length of said line is longer than a predetermined length is satisfied.

4. The computer readable medium according to claim 1, wherein correction of the width of said line is correction to increase the width of said line.

5. An image forming device, which performs image processing comprising raster processing of image data received in vector data form, and executes image forming based on said image data, the image forming device comprising:
a rasterizing unit which, when the image data for said raster processing is image data representing a line, makes a decision as to whether or not to correct the width of said line, based on the width and the angle of inclination from a horizontal direction or from a vertical direction of said line, and when said decision is to correct the width of said line, corrects the width of said line and performs said raster processing for the image data after the correction, whereas when said decision is not to correct the width of said line, performs said raster processing for said received image data.

6. The image forming device according to claim 5, wherein the decision to correct the width of said line is made when the condition that said angle of inclination is smaller than a predetermined angle, and the condition that the width of said line is smaller than a predetermined width, are satisfied.

7. The image forming device according to claim 6, wherein the decision to correct the width of said line is made when a further condition that the length of said line is longer than a predetermined length is satisfied.

8. The image forming device according to claim 5, wherein correction of the width of said line is correction to increase the width of said line.

9. The computer readable medium according to claim 2, wherein correction of the width of said line is correction to increase the width of said line.

10. The computer readable medium according to claim 3, wherein correction of the width of said line is correction to increase the width of said line.

11. The image forming device according to claim 6, wherein correction of the width of said line is correction to increase the width of said line.

12. The image forming device according to claim 7, wherein correction of the width of said line is correction to increase the width of said line.
